(19) United States
(12) Patent Application Publication
(10) Pub. No.: US 2008/0313742 A1
(43) Pub. Date: Dec. 18, 2008

(54) METHOD AND SYSTEM FOR RESTRICTING THE USERS OF MEDIA CONTENT

(75) Inventors: Quan QI, Shenzhen (CN); Yimin LI, Shenzhen (CN); Renzhou ZHANG, Shenzhen (CN)

Correspondence Address: Leydig, Voit & Mayer, Ltd;(for Huawei Technologies Co., Ltd), Two Prudential Plaza Suite 4900, 180 North Stetson Avenue, Chicago, IL, 60601, US

(73) Assignee: Huawei Technologies Co., Ltd., Shenzhen (CN)

(21) Appl. No.: 12/192,982

(22) Filed: Aug. 15, 2008

Related U.S. Application Data
(63) Continuation of application No. PCT/CN2007/000563, filed on Feb. 15, 2007.

(30) Foreign Application Priority Data
Feb. 17, 2006 (CN) 200610008355.0

(51) Int. Cl. G06F 21/00

(52) U.S. Cl. 726/27

(57) ABSTRACT

A method, a system, a Rights Issuer and a user terminal are provided for restricting the users of media content. For restricting the users of media content, a DRM agent inside a user terminal obtains the copyright control information that carries the user identity of the current media content, receives a rights verification request that carries the identity of the current initiator of the current media content, and checks whether the current initiator can trigger the play of the current media content according to the user identity in the copyright control information mentioned previously and the identity of the current initiator carried in the rights verification request. If the current initiator is allowed to trigger the play of the current media content, the DRM agent provides the current decrypted media content to a media player. Otherwise, the DRM agent forbids the media player to play the current media content. The users of media content can be restricted based on the actual service requirements and thus a media content provider can better control the right to use its media content.

### CROSS-REFERENCE TO RELATED APPLICATION

This application is a continuation under 35 U.S.C. § 120 of International Application PCT/CN2007/000563, filed Feb. 15, 2007, which claims the benefit of Chinese Patent Application No. 200610008355.0, filed with the Chinese Patent Office on Feb. 17, 2006 and entitled “METHOD AND SYSTEM FOR RESTRICTING THE USERS OF MEDIA CONTENT”, each of which is incorporated by reference in its entirety herein.

### FIELD OF THE INVENTION

The present invention relates to Digital Rights Management (DRM), in particular, to a method and a system for restricting the entity that can cause the use of media content by a media player.

### BACKGROUND

DRM is a new technology that emerges along with the popularization of streaming media on the Internet. It aims to protect the copyright of digital content, raise the technical threshold and the cost of piracy, and ensure that only authorized users have access to the digital content on the precondition of following the specified copyright rules.

The DRM technology includes the following steps:

An issuer of media content encrypts media content in the form of digital signals and then uploads it to a network. A user terminal downloads the encrypted media content from the network to a DRM agent inside the user terminal.

The DRM agent inside the user terminal obtains copyright control information of the media content from a Rights Issuer (RI). The copyright control information includes a decryption key and rights information of the media content.

The DRM agent inside the user terminal decrypts the downloaded media content using the decryption key in the copyright control information, and operates the decrypted media content according to the rights information in the copyright control information. The rights information is to define the user terminal that can consume the media content, the types of operation such as play, print, export or execution that can be performed on the media content, and the time range and the number of times of the operation that can be performed on the media content.

In existing DRM technology, the rights information that a user terminal obtains from the RI does not include the information about the entities that can cause the use of the media content on the user terminal; that is, the rights information does not define which application(s) can cause the play of the media content or whether the terminal user himself/herself can cause the play of the media content. Therefore, a provider of the media content cannot exactly control the right to use the provider's media content.

### SUMMARY

An object of the present invention is to provide a method and system for restricting the entities that can cause the use of a media content by some media player so as to improve the control over the media content.

Another object of the present invention is to provide a Rights Issuer (RI) that can restrict the entities that can cause the use of media content by some media player and can improve the control over media content.

Another object of the present invention is to provide a type of user terminal via which the entities that can cause the use of media content by some media player can be restricted and thereby the control over media content can be improved.

To attain the above objects, the present invention provides a method for restricting the entities that can cause the use of media content, including the following steps:

A DRM agent inside a user terminal obtains the copyright control information that carries the identities of the entities that can cause the use of the current media content by some media player;

The DRM agent inside the user terminal checks whether the current entity that causes the play of the media content can cause the play of the current media content according to the user identity in the copyright control information mentioned previously. If said entity is allowed to cause the play of the current media content, the DRM agent allows a media player to play the current media content. Otherwise, the DRM agent forbids the media player to play the current media content.

To attain the above objects, the present invention also provides a system for restricting the users of media content, including an RI, a DRM agent inside a user terminal and a media player inside the user terminal.

The RI adds the user identity mapping the identity of the current media content to the copyright control information of the current media content and sends the copyright control information to the DRM agent inside the user terminal.

The DRM agent inside the user terminal receives the copyright control information that carries the user identity of the current media content, and determines whether the current initiator can trigger the play of the current media content according to the user identity carried in the copyright control information. If the current initiator is allowed to trigger the play of the current media content, the DRM agent decrypts the current media content and sends it to the media player inside the user terminal. If the current initiator is forbidden to trigger the play of the current media content, the DRM agent sends a failure message to the media player inside the user terminal.

The media player inside the user terminal plays the media content after receiving the decrypted media content from the DRM agent, or does not play the current media content after receiving the failure message from the DRM agent.

To attain the above objects, the present invention also provides an RI for restricting the users of media content, including an interface unit and a generation unit.

The generation unit generates and initializes the copyright control information of the current media content, obtains the user identity of the current media content, writes the user identity it obtains into the copyright control information, and then sends the copyright control information to the interface unit.

The interface unit receives the copyright control information that carries the user identity of the current media content from the generation unit and then sends the copyright control information to the DRM agent inside the user terminal.

The user terminal for restricting the users of media content according to an embodiment of the present invention includes a DRM agent and a media player.

The DRM agent receives the copyright control information that carries the user identity of the current media content, and determines whether the current initiator can trigger the play of the current media content according to the user identity carried in the copyright control information. If the current initiator is allowed to trigger the play of the current media content, the DRM agent decrypts the current media content and sends it to the media player. If the current initiator is forbidden to trigger the play of the current media content, the DRM agent sends a failure message to the media player.

The media player plays the current media content after receiving the decrypted media content from the DRM agent, or does not play the current media content after receiving the failure message from the DRM agent.

Obviously, according to the embodiments of the present invention, the RI can send the user identity of the current media content as the rights information of the current media content to the DRM agent inside the user terminal. When any initiator on the user terminal needs to trigger the play of the media content, the DRM agent can determine whether the current initiator is legal according to the user identity of the media content before allowing the current initiator to trigger the media player to play the media content. In this way, the users of the media content are controlled according to the actual service requirements and thus the provider of the media content can better control the right to use the media content.

### BRIEF DESCRIPTION OF THE DRAWINGS

FIG. 1 shows the structure of the system for restricting the users of media content according to an embodiment of the present invention.

FIG. 2 shows the basic structure of the RI for restricting the users of media content according to an embodiment of the present invention.

FIG. 3 shows the first structure of the RI for restricting the users of media content according to an embodiment of the present invention.

FIG. 4 shows the second structure of the RI for restricting the users of media content according to an embodiment of the present invention.

FIG. 5 shows the third structure of the RI for restricting the users of media content according to an embodiment of the present invention.

FIG. 6 shows the basic structure of the user terminal for restricting the users of media content according to an embodiment of the present invention.

FIG. 7 shows a flowchart of the method for restricting the users of media content according to an embodiment of the present invention.

### DETAILED DESCRIPTION

The following drawings and embodiments are intended to further demonstrate and illustrate the present invention, but not to limit the scope of the present invention.

In the existing DRM technology, the copyright control information a user terminal obtains does not include the information about the entities that can cause the use of the media content on the user terminal. Therefore, any entities on the user terminal, such as an application inside the user terminal, can serve as a legal entity of the media content to cause the play of the media content.

To solve the aforementioned problem, an embodiment of the present invention provides a method for restricting the entity that can cause the use of the media content: A DRM agent inside a user terminal obtains the copyright control information that carries the entity identity of the current media content; the DRM agent checks whether the current entity can cause the play of the current media content according to the entity identity in the copyright control information mentioned previously; if the current entity is allowed to cause the play of the current media content, the DRM agent allows a media player to play the current media content. Otherwise, the DRM agent forbids the media player to play the current media content.

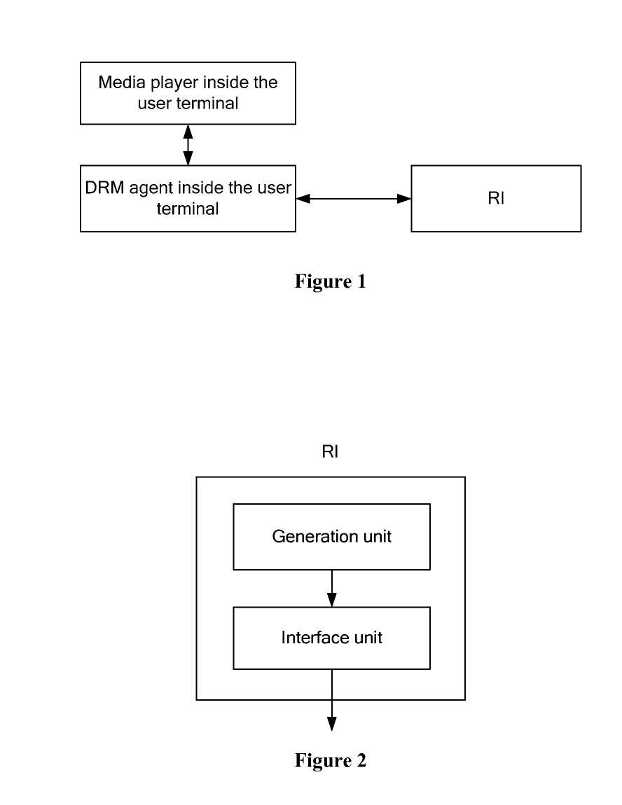

To solve the aforementioned problem, an embodiment of the present invention also provides a system for restricting the entity that can cause the use of the media content. FIG. 1 shows the structure of the system for restricting the entity that can cause the use of the media content according to an embodiment of the present invention. As shown in FIG. 1, the system for restricting the entity that can cause the use of the media content according to an embodiment of the present invention includes an RI, a DRM agent inside the user terminal and a media player inside the user terminal.

The RI adds the entity identity mapping the identity of the current media content to the copyright control information of the current media content and sends the copyright control information to the DRM agent inside the user terminal.

The DRM agent inside the user terminal receives the copyright control information that carries the entity identity of the current media content, and determines whether the current entity can cause the play of the current media content according to the entity identity carried in the copyright control information. If the current entity is allowed to cause the play of the current media content, the DRM agent decrypts the current media content and sends it to the media player inside the user terminal. If the current entity is forbidden to cause the play of the current media content, the DRM agent sends a failure message to the media player inside the user terminal.

The media player inside the user terminal plays the media content after receiving the decrypted media content from the DRM agent, or does not play the current media content after receiving the failure message from the DRM agent.

To solve the problem described previously, an embodiment of the present invention also provides an RI for restricting the entity that can cause the use of media content. FIG. 2 shows the basic structure of the RI for restricting the entity that can cause the use of media content according to an embodiment of the present invention. As shown in FIG. 2, the RI for restricting the entity that can cause the use of media content according to an embodiment of the present invention may include an interface unit and a generation unit.

The generation unit generates and initializes the copyright control information of the current media content, obtains the entity identity mapping the identity of the current media content, writes the obtained entity identity into the copyright control information, and then sends the copyright control information to the interface unit.

The interface unit receives the copyright control information that carries the entity identity of the current media content from the generation unit and then sends the copyright control information to the DRM agent inside the user terminal.

The RI for restricting the entity that can cause the use of media content according to an embodiment of the present invention may include the following three structures.

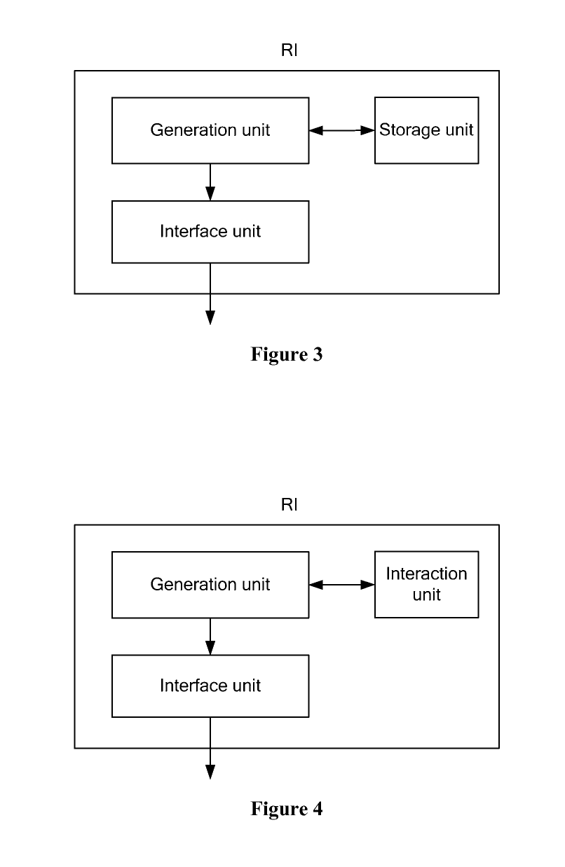

FIG. 3 shows the first structure of the RI for restricting the entity that can cause the use of media content according to an embodiment of the present invention. As shown in FIG. 2 and FIG. 3, the RI may further include a storage unit used to store a mapping between media content identities and the entity identities, in addition to the units in the basic structure of the RI for restricting the entity that can cause the use of media content according to an embodiment of the present invention. In this way, the generation unit obtains the entity identity mapping the identity of the current media content from the storage unit according to the identity of the current media content.

FIG. 4 shows the second structure of the RI for restricting the entity that can cause the use of media content according to an embodiment of the present invention. As shown in FIG. 2 and FIG. 4, the RI may further include an interaction unit used to prompt the administrator to enter the entity identity of the current media content and to send the entity identity entered by the administrator to the generation unit, in addition to the units in the basic structure of the RI for restricting the users of media content according to an embodiment of the present invention. In this way, the generation unit obtains the entity identity from the interaction unit and then writes the obtained entity identity into the copyright control information described previously.

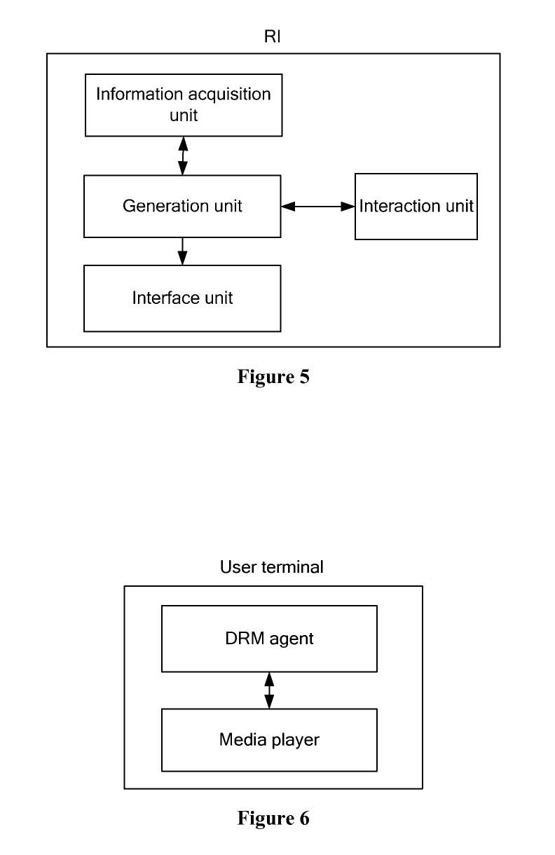

FIG. 5 shows the third structure of the RI for restricting the entity that can cause the use of media content according to an embodiment of the present invention. As shown in FIG. 2 and FIG. 5, the RI may further include an information acquisition unit and an interaction unit, in addition to the units in the basic structure of the RI for restricting the entity that can cause the use of media content according to an embodiment of the present invention. The information acquisition unit obtains and stores multiple entity identities. The generation unit described previously sends the multiple user identities stored in the information acquisition unit to the interaction unit, obtains the entity identity returned by the interaction unit, and writes the obtained entity identity from the interaction unit into the copyright control information previously described. The interaction unit displays the received multiple entity identities from the generation unit and sends the entity identity chosen and entered by the administrator to the generation unit.

To solve the problem described previously, an embodiment of the present invention also provides a type of user terminal for restricting the entity that can cause the use of media content. FIG. 6 shows the basic structure of the user terminal for restricting the entity that can cause the use of media content according to an embodiment of the present invention. As shown in FIG. 6, the user terminal according to an embodiment of the present invention includes a DRM agent and a media player.

The DRM agent receives the copyright control information that carries the entity identity of the current media content, and determines whether the current entity can cause the play of the current media content according to the user entity carried in the copyright control information. If the current entity is allowed to cause the play of the current media content, the DRM agent decrypts the current media content and sends it to the media player. If the current entity is forbidden to cause the play of the current media content, the DRM agent sends a failure message to the media player.

The media player plays the media content after receiving the decrypted media content from the DRM agent, or does not play the current media content after receiving the failure message from the DRM agent.

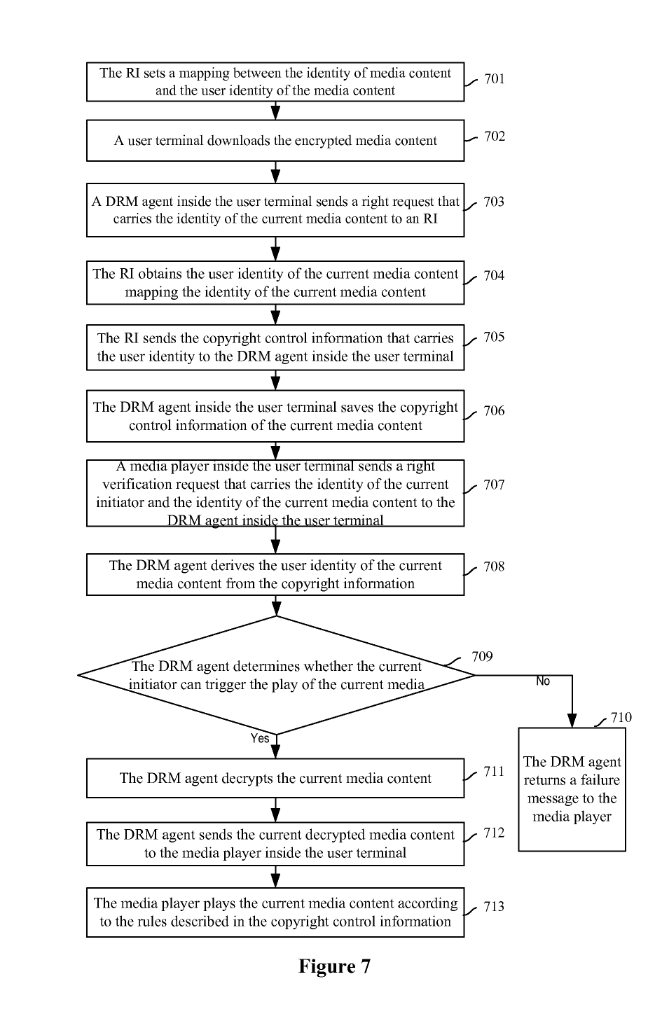

FIG. 7 shows the flowchart of the method for restricting the entity that can cause the use of media content according to an embodiment of the present invention. As shown in FIG. 1 and FIG. 7, the method for restricting the entity that can cause the use of media content according to an embodiment of the present invention includes the following blocks.

In block 701, a mapping between the identity of media content and the entity identity of the media content is preset.

In order to enable a media content provider to better control the media content it provides, the RI may set a mapping between the identity of the media content and the entity identity of the media content according to the actual requirements of the media content provider. The entity identity described herein may be any kind of information that can determine the entity of the media content, such as the name, address, or authentication information of the user.

During the setting of the mapping described previously, the entity identity of media content may be the identity of an entity or multiple entities that can cause the play of the media content. For instance, if the media content is a song such as song 1 and if only a specific game program such as the application of game 1 is allowed to cause the play of song 1, the RI may preset a mapping between the identity of song 1 and the identity of the application of game 1, that is, the identity of the application of game 1 is set as the entity identity of the media content (song 1).

During the setting of the mapping described previously, the entity identity of media content may also be the identity of an entity or multiple entities that are forbidden to cause the play of the media content. For instance, if the media content is a picture such as picture 1 and if a specific application such as application 3 is forbidden to cause picture 1, the RI may preset a mapping between the identity of picture 1 and the identity of application 3, that is, the identity of application 3 is set as the identity of an entity that is forbidden to cause the play of the media content (picture 1).

In block 702, a user terminal downloads the encrypted media content from a network.

In block 703, a DRM agent inside the user terminal sends a rights request that carries the identity of the current media content to the RI in the network.

In block 704, the RI in the network receives the rights request that carries the identity of the current media from the DRM agent and obtains the entity identity of the current media content according to the present mapping between the identity of the current media content and the entity identity of the current media content.

It should be noted that the setting of a mapping between the identity of the media content and the entity identity of the media content as described in block 701 according to an embodiment of the present invention may be omitted. If such setting is omitted, then block 704 changes as follows:

The RI in the network receives the rights request that carries the identity of the current media from the DRM agent and prompts the administrator to enter the entity identity of the current media content;

After the administrator enters the entity identity of the current media content, the RI obtains the entity identity mapping the identity of the current media content that the administrator enters.

Alternatively, block 701 in the method for restricting the entity that can cause the use of media content according to an embodiment of the present invention may be changed to the setting of multiple entity identities. Then block 704 changes as follows:

The RI in the network receives the rights request that carries the identity of the current media from the DRM agent, prompts the administrator to enter the entity identity of the current media content, and presents the preset multiple entity identities to the administrator;

When the administrator chooses and enters one of the entity identities, the RI obtains the entity identity mapping the identity of the current media content.

In block 704, the entity identity of media content may be the identity of an entity or multiple entities that can cause the play of the media content or may be the identity of an entity or multiple entities that are forbidden to cause the play of the media content.

In block 705, the RI adds the obtained entity identity to the copyright control information it constructs and sends the copyright control information that carries the entity identity to the DRM agent inside the user terminal. In the method for restricting the entity that can cause the use of media content according to an embodiment of the present invention, this block differs from the existing DRM technology in that the copyright control information constructed by the RI carries the identity, the decryption key and the rights information of the current media content.

According to the embodiments of the present invention, an entity parameter can be preset in the copyright control information, so that the entity identity the RI obtains can be carried in the initiators parameter in the copyright control information the RI constructs. It should also be noted that at present a Rights Expression Language (RLE) is used to describe the rights information of media content in the copyright control information. The rights information defines the user terminals that can play the media content, the types of operation such as play, print, export or execution that can be performed on the media content, and the time range and the number of times of the operation that can be performed on the media content.

The existing REL defines seven models for describing rights information. One of the models is the constraint model. In the constraint model, the Constraint parameter describes the constraints or limitations on the use of media content, such as the number of times that the media content can be played. Therefore, according to the embodiments of the present invention, a better way is to utilize the Constraint parameter in the REL to restrict the entities that can cause the use of media content. In other words, in block 705, the RI may use the Constraint parameter in the copyright control information the RI constructs to carry the entity identity the RI obtains. The RI adds an initiators element in the Constraint parameter in advance to describe the information about the entities that can cause the play of the media content and writes the entity identity the RI obtains into the new initiators element in the Constraint parameter in the copyright control information, so that the copyright control information carries the entity identity the RI obtains. The new initiators element can assume a format as defined in the following table:

| | |
|---|---|
| Element | <!ELEMENToma-dd:initiators (oma-dd:human?, |
| | oma-dd:application*)> |
| Semantics | The initiators element defines a list of entities that are |
| | allowed to cause the use of associated media content. |
| | The entity could be either human or applications. |
| | The human sub-element may appear for zero or one time. |
| | The application sub-element may appear zero or more times. |
| Element | <!ELEMENT oma-dd:human EMPTY> |
| Semantics | The human element neither has any sub-element nor has any |
| | attribute. When present as a sub-element of the initiators |
| | element, it indicates that human (instead of application) |
| | is allowed to cause the play of the media content by some |
| | media player. |
| | When not present in the initiators element, it indicates that no |
| | human is allowed to cause the play of the media content |
| | by any media player. |
| Element | <!ELEMENT oma-dd:application EMPTY> |
| Semantics | The application element does not have any sub-element. |
| Attribute | <!ATTLIST oma-dd:application oma-dd:name |
| | ID #REQUIRED> |
| Semantics | The application element must have a name attribute to |
| | uniquely identify the name of each application. |
| | When the name attribute assumes avalue “*”, |
| | it represents all applications. |
| Attribute | <!ATTLIST oma-dd:application oma-dd:version #IMPLIED> |
| Semantics | The application element can have a version attribute indicating |
| | the version of the application. |
| Attribute | <!ATTLIST oma-dd:application oma-dd:include |
| | (TRUE\|FALSE) |
| | #REQUIRED> |
| Semantics | The application element must have an include attribute, |
| | the value of which is either TRUE indicating that the |
| | application is allowed to cause the play of media content or |
| | FALSE indicating that the application is not allowed to cause |
| | the play of the media content. |

In block 706, the DRM agent inside the user terminal saves the copyright control information of the current media content received from the RI. In block 707, to cause the play of the current media content, the current entity on the user terminal enters a play request that carries the identity of the current entity and the identity of the current media content to a media player inside the user terminal. Then the media player sends a rights verification request that carries the identity of the current entity and the identity of the current media content to the DRM agent inside the user terminal.

In block 707, the current entity described herein may be an entity on the user terminal or any application inside the user terminal such as the startup program or a game program inside the user terminal.

In block 707 in the method for restricting the entities that can cause the use of media content according to an embodiment of the present invention, if the current entity is a user, then the user directly enters a play request that carries the identity of the user itself and the identity of the current media content to the media player inside the user terminal. Upon receipt of the play request from the user, the media player adds the identity of the user and the identity of the current media content to a rights verification request and then sends the rights verification request to the DRM agent.

In block 707 in the method for restricting the entities that can cause the use of media content according to an embodiment of the present invention, if the current entity is an application, then the application sends a play request that carries both the identity of the application itself and the identity of the current media content to the media player after receiving a user-input setting command that carries the identity of the current media content. Upon receipt of the play request from the application, the media player adds the identity of the application and the identity of the current media content to a rights verification request and then sends the rights verification request to the DRM agent inside the user terminal. For instance, if a user runs the application of game 1 on the user terminal and hopes to set the current media content such as song 1 as the background music of this application, the user may enter a setting command that carries the identity of song 1. Upon receipt of the setting command that carries the identity of song 1 from the user, the application of game 1 sends a play request that carries both the identity of the application of game 1 and the identity of song 1 to the media player inside the user terminal. Then the media player sends a rights verification request that carries the identity of the application of game 1 and the identity of song 1 to the DRM agent inside the user terminal.

In block 708, the DRM agent inside the user terminal derives the entity identity of the current media content from the copyright information of the current media the DRM agent saves.

In block 708, the DRM agent inside the user terminal may derive the entity identity of the current media content from the initiators parameter in the copyright control information of the current media content the DRM agent saves. For instance, if the RI writes the obtained entity identity into the initiators element in the constructed copyright control information in block 705 in the method for restricting the entities that can cause the use of media content according to an embodiment of the present invention, then the DRM agent derives the entity identity of the current media content from the initiators element in the copyright control information in block 708.

It should be noted that if the copyright control information the RI obtains carries the identity of an entity or multiple entities that can cause the play of the media content in block 704 previously described, then the entity identity the DRM agent derives in block 708 is also the identity of the entity or multiple entities that can cause the play of the media content; if the copyright control information the RI obtains carries the identity of an entity or multiple entities that are forbidden to cause the play of the media content in step 704 previously described, then the entity identity the DRM agent derives in block 708 is also the identity of the entity or multiple entities that are forbidden to cause the play of the media content.

In block 709, the DRM agent determines whether the current entity can cause the play of the current media content according to the entity identity the DRM agent derives from the rights control information and the identity of the current entity carried in the rights verification request. If the current entity can cause the play of the current media content, block 711 follows. Otherwise, block 710 follows.

In block 709, if the entity identity the DRM agent derives from the rights control information is the identity of an entity or multiple entities that can cause the play of the media content, the DRM agent determines whether the identity of the current entity carried in the rights verification request is included in the entity identity the DRM agent obtains. If the identity of the current entity carried in the rights verification request is included in the user identity the DRM agent obtains, the DRM agent considers that the current entity can cause the play of the current media content.

In block 709, if the entity identity the DRM agent derives from the rights control information is the identity of an entity or multiple entities that are forbidden to cause the play of the media content, the DRM agent determines whether the identity of the current entity carried in the rights verification request is included in the entity identity the DRM agent obtains. If the identity of the current entity carried in the rights verification request is not included in the entity identity the DRM agent obtains, the DRM agent considers that the current entity can trigger the play of the current media content.

In block 710, the DRM agent inside the user terminal returns a failure message to the media player. The procedure thus ends.

In block 710, upon receipt of the failure message from the DRM agent, the media player may further return the failure message to the current entity on the user terminal. If the current entity is the terminal user itself, the media player may directly indicate that the user setting is unsuccessful. If the current entity is an application inside the user terminal, the media player may return the failure message to the application and the application may also present the failure message to the user.

In block 711, the DRM agent inside the user terminal obtains the decryption key from the copyright control information of the current media content and decrypts the current media content using the decryption key the DRM agent obtains.

In block 712, the DRM agent sends the current decrypted media content to the media player inside the user terminal.

In block 713, the media player inside the user terminal plays the current media content according to the rules described in the copyright control information.

While this invention has been particularly shown and described with reference to preferred embodiments thereof, it will be understood by those skilled in the art that various changes in form and details may be made therein without departing from the spirit and scope of the invention as defined by the appended claims.

What is claimed is:

1. A method for restricting the operation of media content, comprising:
obtaining copyright control information of current content carrying an identity of an entity that can cause the use of the media content;
checking whether a current entity that tries to cause the use of the current media content is entitled to cause the use of the current media content according to the entity identity in the copyright control information; and
allowing the use of the current media content if the current entity is entitled to cause the use of the current media content.

2. The method according to claim 1, comprising:
implementing the process of checking whether the current entity is entitled to cause the use of the current media content in response to receiving a rights verification request carrying an identity of the current entity for the current media content.

3. The method according to claim 1, wherein the entity identity is an identity of an entity that is entitled to cause the use of the media content;
wherein the process of checking whether the current entity is entitled to cause the use of the current media content comprises:
checking whether the identity of the current entity is included in the entity identities carried in the copyright control information; and
confirming that the current entity is entitled to cause the use of the current media content if the current entity is included in the entity identities carried in the copyright control information.

4. The method according to claim 1, wherein the entity identity is an identity of an entity that is forbidden to cause the use of the media content;
wherein the process of checking whether the current entity is entitled to cause the use of the current media content comprises:
checking whether the identity of the current entity is included in the entity identities carried in the copyright control information; and
confirming that the current entity is entitled to cause the use of the current media content if the current entity is not included in the entity identities carried in the copyright control information.

5. The method according to claim 1, wherein the current entity is a terminal user itself, the process of checking whether a current entity that tries to cause the use of the current media content is entitled to cause the use of the current media content comprises:
receiving a play request entered by the terminal user carrying an identity of the terminal user and an identity of the current media content; and
checking whether the terminal user can cause the play of the current media content according to the entity identity received from the rights control information, the identity of the terminal user received from the terminal user and the identity of the current media content.

6. The method according to claim 1, wherein the current entity is an application inside a user terminal; the process of checking whether a current entity that tries to cause the use of the current media content is entitled to cause the use of the current media content comprises:
receiving a play request carrying an identity of the application and an identity of the current media content sent by the application according to a user-input setting command carrying the identity of the current media content; and
checking whether the application can cause the play of the current media content according to the entity identity received from the rights control information, the identity of the application received from the application and the identity of the current media content.

7. A method for restricting the operation of media content, comprising:
generating a copyright control information of a current media content carrying an entity identity corresponding to an identity of the current media content, wherein the entity identity indicating an entity that can cause the use of the media content; and
sending the copyright control information to a user terminal.

8. The method according to claim 7, wherein the process of generating a copyright control information of a current media content carrying an entity identity corresponding to an identity of the current media content comprise:
generating a copyright control information of the current media content;
obtaining the entity identity corresponding to the identity of the current media content; and
adding the obtained entity identity into the copyright control information.

9. The method according to claim 8, further comprising:
receiving a rights request carrying the identity of the current media; and
wherein the process of obtaining the entity identity corresponding to the identity of the current media content comprises:
obtaining the entity identity corresponding to the identity of the current media content via the preset mapping between the identity of the current media content and the entity identity according to the received identity of the current media.

10. The method according to claim 8, further comprising:
receiving a rights request carrying the identity of the current media;
wherein the process of obtaining the entity identity corresponding to the identity of the current media content comprises:
prompting an administrator to enter the entity identity of the current media content according to the received identity of the current media; and
obtaining the entity identity corresponding to the identity of the current media content when the administrator enters the entity identity of the current media content.

11. The method according to claim 10, wherein the process of prompting the administrator to enter the entity identity of the current media content comprises:
prompting the administrator preset multiple entity identities to choose at least one of the entity identities.

12. The method according to claim 8, wherein the process of adding the obtained entity identity into the copyright control information comprises:
adding the obtained entity identity to an initiators parameter preset in the copyright control information.

13. A rights issuer, comprising a generation and a interface unit, wherein:
the generation unit is adapted to generate a copyright control information of a current media content, obtain a entity identity corresponding to an identity of the current media content, add the obtained entity identity into the copyright control information, and send the copyright control information to the interface unit; and
the interface unit is adapted to receive the copyright control information carrying the entity identity of the current media content and send the copyright control information to a user terminal.

14. The rights issuer according to claim 13, wherein the rights issuer further comprises:
a storing unit, adapted to store a mapping between the identity of the current media content and the entity identity; and
wherein the generation unit is further adapted to obtain the entity identity corresponding to the identity of the current media content according to the identity of the current media content according to the mapping.

15. The rights issuer according to claim 13, wherein the rights issuer further comprises:
an interaction unit adapted to prompt an administrator to enter the entity identity of the current media content and sending the entity identity entered by the administrator to the generation unit; and
wherein the generation unit is further adapted to obtain the entity identity from the interaction unit.

16. The rights issuer according to claim 15, wherein the rights issuer further comprises an information acquisition unit;
the information acquisition unit is adapted to obtain and store multiple entity identities;
wherein the generation unit is further adapted to send the multiple entity identities stored by the information acquisition unit to the interaction unit, obtain the entity identity from the interaction unit; and
wherein the interaction unit is further adapted to present the received multiple entity identities to the administrator and send the entity identity entered by the administrator to the generation unit.

17. A user terminal, comprising an DRM agent and a media player, wherein:
the DRM agent is adapted to receive copyright control information of a current media content carrying an entity identity, send the decrypted current media content to the media player in response to confirming that a current entity is entitled to play the current media content according to the entity identity carried in the copyright information and send a failure message to the media player in response to confirming that a current entity is forbidden to play the current media content according the entity identity carried in the copyright information; and
the media player is adapted to play the current media content in response to receiving the decrypted current media content and forbid to play the current media content in response to receiving the failure message.

18. The method according to claim 9, wherein the process of adding the obtained entity identity into the copyright control information comprises:
adding the obtained entity identity to an initiators parameter preset in the copyright control information.

19. The method according to claim 10, wherein the process of adding the obtained entity identity into the copyright control information comprises:
adding the obtained entity identity to an initiators parameter preset in the copyright control information.

20. The method according to claim 11, wherein the process of adding the obtained entity identity into the copyright control information comprises:
adding the obtained entity identity to an initiators parameter preset in the copyright control information.
